(19) United States
(12) Patent Application Publication
(10) Pub. No.: US 2025/0208438 A1
(43) Pub. Date: Jun. 26, 2025

(54) Spectacle Structure

(71) Applicant: TEAMWORKS GLASSES CORP., Tainan (TW)

(72) Inventor: Mei-Yueh Hou, Tainan (TW)

(73) Assignee: TEAMWORKS GLASSES CORP., Tainan (TW)

(21) Appl. No.: 18/389,798

(22) Filed: Dec. 20, 2023

(51) Int. Cl. G02C 5/22

(52) U.S. Cl. CPC G02C 5/2254

(57) ABSTRACT

The present invention provides a spectacle structure that includes a frame, two elastic members, and two temples, respectively, arranged thereon. The two elastic members are respectively assembled in the receiving grooves of two pivoting parts of the frame. The elastic member has a positioning end provided at one end thereof and snapped in an engaging groove of the frame, and a resisting end provided at the other end thereof and resisted to the temple. The temple has a pivoting lug provided at a front end thereof, and the front end surface of the pivoting lug is resisted by the resisting end of the elastic member when the temple is assembled in the pivoting part of the frame. Due to the elastic members between the temples and the frame, the temples can be unfolded elastically when worn, and the temples can be stably positioned when being unfolded or folded.

### BACKGROUND OF THE PRESENT INVENTION

### Field of Invention

The invention relates to a spectacle structure that allows the temples to be elastically folded outward and firmly positioned when the temples are folded inward.

### Description of Related Arts

Generally, a spectacle is mainly consists of a frame and two temples. The frame has pivoting parts arranged on the two ends thereof, while each of the two temples has a pivoting lug arranged at the front end thereof. The temples are respectively pivotally connected to the two sides of the frame through pivoting elements. When wearing spectacle, the temples need to be rotated and unfolded outward with the pivot joint between the temples and the frame as the axis, and the unfolding angle between the temples and the frame can only be turned to about 90 degrees, that is, they can no longer be unfolded outward. Therefore, when wearing it, the rear ends of the temples must be pulled outward to make it easier to wear. The temples have no elasticity, so when wearing spectacle, the temples often break due to pulling outward. Moreover, the temples are easily deformed after being worn and pulled open many times, resulting in their inability to be worn stably on the face. Therefore, the spectacle is prone to loosening and slipping when worn, so wearing them is not comfortable. In addition, when the spectacle is not worn, the two temples must be folded towards the frame. Many people will clip the temples to the neckline or pocket of their clothes when they are not wearing their spectacle. However, the pivoting parts of spectacle are prone to loosening after the temples are pulled outward many times, causing the temples to randomly open outward even after being folded into the frame, thus preventing them from securely attaching to the frame. As a result, the temples lose their clamping function, and the spectacle is prone to falling off from the neckline or pocket, leading to possible damage.

### SUMMARY OF THE PRESENT INVENTION

The main purpose of the present invention is to provide a spectacle structure that enables the temples to be elastically folded outward and to be stably positioned when folded inward.

The spectacle structure of the present invention, includes a frame, two elastic members, and two temples respectively arranged thereon, wherein the frame has a pivoting part each provided at two ends thereof, a slot provided in the pivoting part, a through hole provided on the pivoting part and penetrates the slot, a pivoting element provided in the through hole, a receiving groove provided in the slot, and an engaging groove each corresponding to the upper and lower sides of one side of the receiving groove, wherein the two elastic members are respectively assembled in the receiving grooves of the two pivoting parts of the frame, wherein the elastic member has a positioning end provided at one end thereof and a resisting end provided at the other end thereof, wherein the positioning end is snapped in the engaging groove of the frame, wherein the two temples are respectively assembled on the two pivoting parts of the frame, wherein the temple has a pivoting lug provided at a front end thereof and arranged in the slots of the frame, a passing hole provided on the pivoting lug, and a front end surface of the pivoting lug resisted by the resisting end of the elastic member.

In the spectacle structure of the present invention, the pivoting element includes a fixed sleeve and a screw arranged thereon, wherein the fixed sleeve is inserted into the through hole of the pivoting part of the frame and the passing hole of the temple, wherein the screw is screw-locked in the fixed sleeve.

The spectacle structure of the present invention, wherein its advantages are that: when the spectacle is worn, the temples can be elastically opened outward, so that the temples will not be deformed and broken because they are pulled outward, so that the wearing is more comfortable, and when the spectacle is not in use, the temples can be firmly folded and will not be opened at will, making it more convenient to use.

### BRIEF DESCRIPTION OF THE DRAWINGS

FIG. 1 is an exploded view of an embodiment of the present invention.

FIG. 2 is a partial enlarged view of the embodiment of the present invention.

FIG. 3 is a perspective assembly view of the embodiment of the present invention.

FIG. 4 is an assembled sectional view of the embodiment of the present invention.

FIG. 5 is a perspective view of the temples folded outward according to the embodiment of the present invention.

FIG. 6 is a perspective view of the temples folded according to the embodiment of the present invention.

### DETAILED DESCRIPTION OF THE PREFERRED EMBODIMENT

A preferred embodiment with drawings is provided in detail to illustrate a feasible technical means of the present invention in achieving the above and other uses and functions.

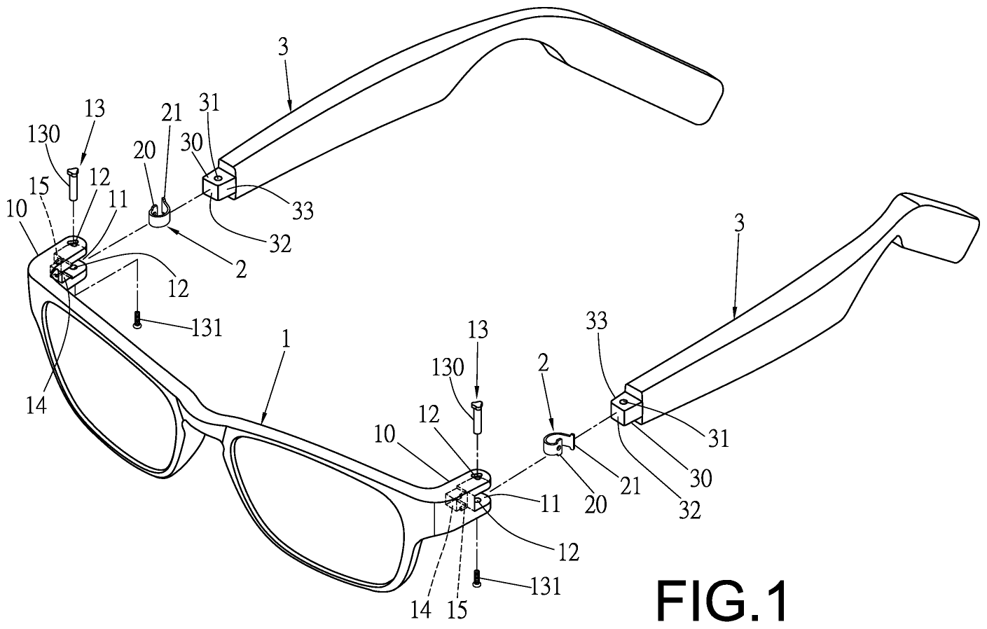

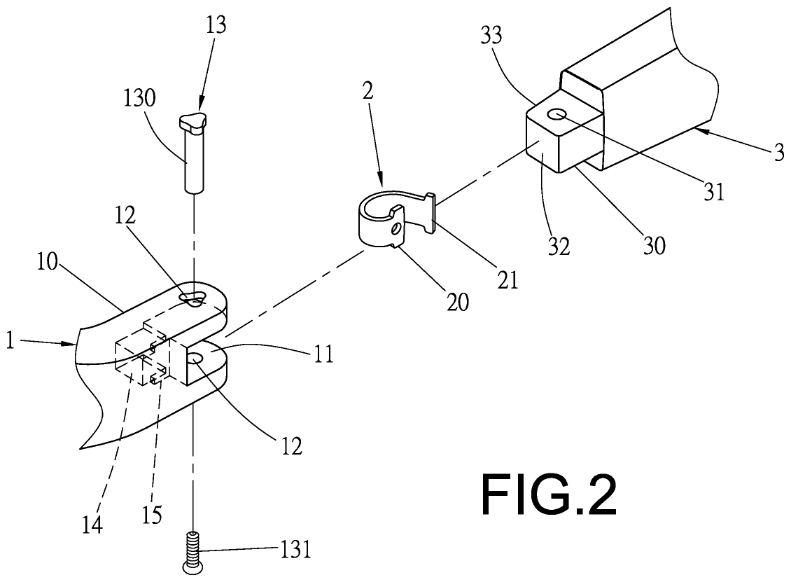

Referring to FIGS. 1 and 2, the spectacle structure of the embodiment of the present invention mainly includes a frame 1, two elastic members 2, and two temples 3 respectively arranged thereon, wherein the frame 1 has a pivoting part 10 each provided at two ends thereof, a slot 11 provided in the pivoting part 10, a through hole 12 provided on the pivoting part 10 and penetrates the slot 11, a pivoting element 13 provided in the through hole 12, a receiving groove 14 provided in the slot 11, and an engaging groove 15 each corresponding to the upper and lower sides of one side of the receiving groove 14, wherein the pivoting element 13 includes a fixed sleeve 130 and a screw 131 arranged thereon, wherein the two elastic members 2 are respectively assembled in the receiving grooves 14 of the two pivoting parts 10 of the frame 1, wherein the elastic member 2 has a positioning end 20 provided at one end thereof and a resisting end 21 provided at the other end thereof, wherein the positioning end 20 is snapped in the engaging groove 15 of the frame 1, wherein the two temples 3 are respectively assembled on the two pivoting parts 10 of the frame 1, wherein the temple 3 has a pivoting lug 30 provided at a front end thereof, a passing hole 31 provided on the pivoting lug 30, and a front end surface 32 of the pivoting lug 30 of the temple 3 resisted by the resisting end 21 of the elastic member 2. In this way, it is a spectacle structure.

When assembling the present invention, referring to FIGS. 1-4. First, inserting the two elastic members 2 separately into the receiving grooves 14 of the pivoting parts 10 of the frame 1. Also, inserting the positioning ends 20 of the elastic member 2 separately into the engaging grooves 15 of the frame 1, while locating the resisting ends 21 of the elastic members 2 inside the slots 11 of the frame 1. Then, inserting the pivoting lugs 30 of the temples 3 into the slots 11 of the frame 1, while resisting the front end surfaces 32 of the pivoting lugs 30 of the temples 3 to the resisting ends 21 of the elastic members 2, causing the resisting ends 21 of the elastic members 2 to be in an elastic compressed state. Aligning the passing holes 31 of the temples 3 with the through holes 12 of the frame 1. Next, passing the fixed sleeves 130 of the pivoting elements 13 through the through holes 12 of the frame 1 and the passing holes 31 of the temples 3, and screwing the screws 131 on the fixing sleeves 130. In this way, the assembly of the entire unit can be completed.

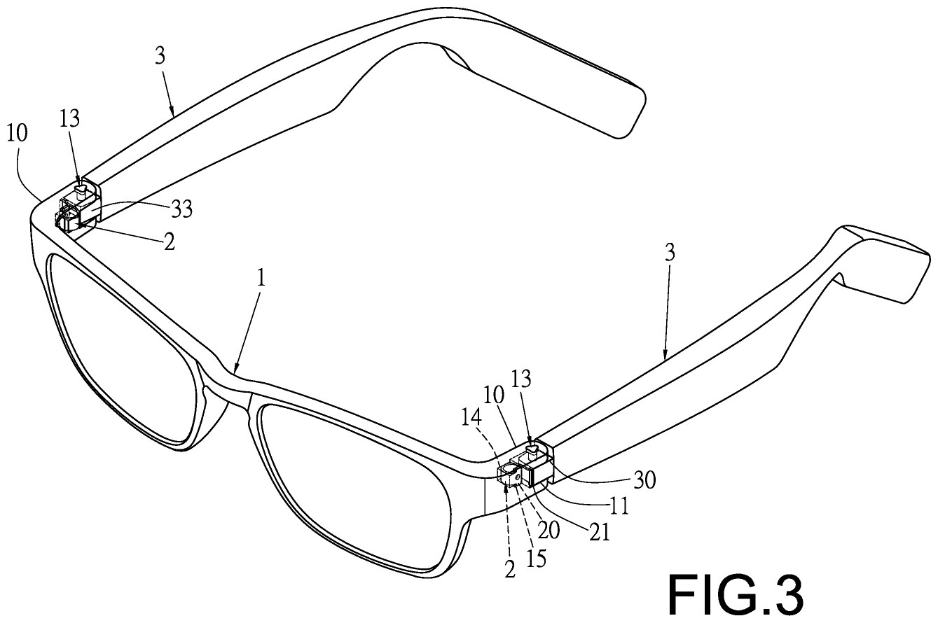

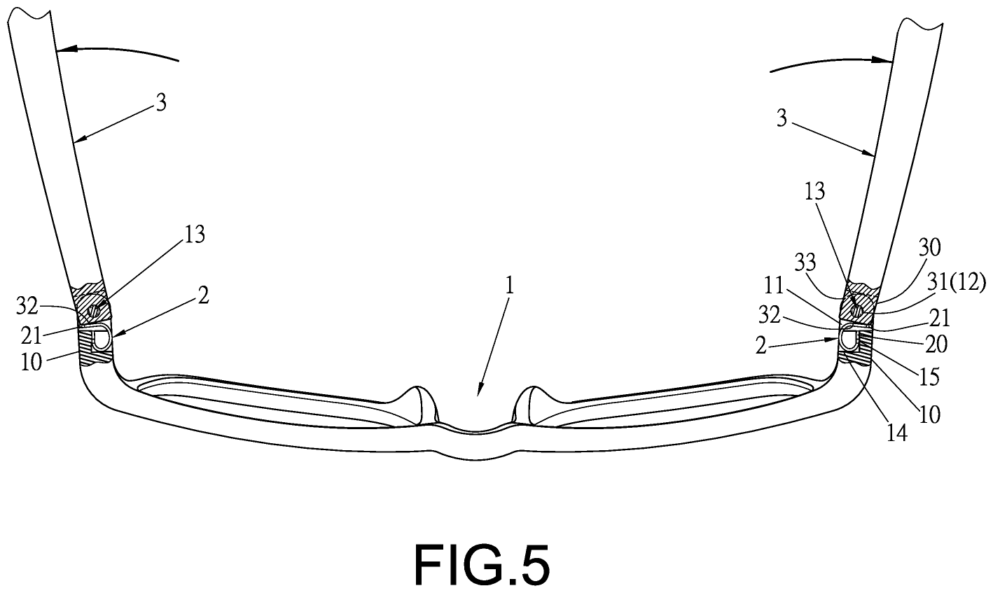

When the present invention is used, refer to FIGS. 3-5, when the user wants to wear spectacle, only need to pull the two temples 3 outward, so that the distance between the two temples 3 is increased, then it can be conveniently worn on the face, when the two temples 3 are stretched outward (as shown in FIG. 5), the front end surfaces 32 of the pivoting lugs 30 of the temples 3 will rotate with the pivoting elements 13 as the support shaft, and resist the resisting ends 21 of the elastic members 2, so that the resisting ends 21 of the elastic members 2 are in an elastic compression state, and when the user wears the spectacle on the face, releases the two temples 3, and the resisting ends 21 of the two elastic members 2 are elastically restored, and the two temples 3 are pushed back to the original position, so that the two temples 3 can be firmly worn on the user's face. In the present invention, the elastic members 2 are provided in the pivoting parts 10 of the frame 1 so that the temples 3 are allowed to elastically expand, thereby providing the user with more convenience and comfort when wearing spectacle.

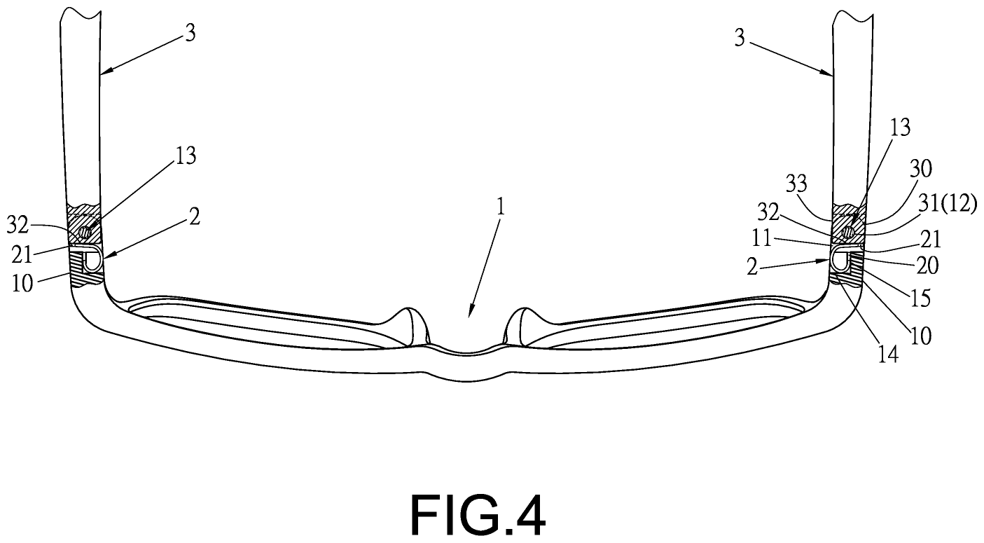

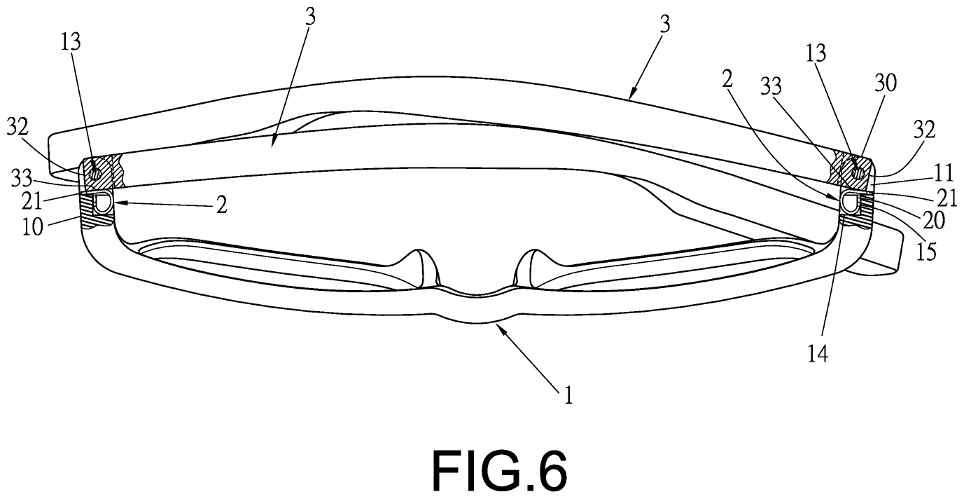

When the spectacle of the invention is not in use, refer to FIG. 6, only a force needs to be applied to the two temples 3 to fold towards the frame 1, and the two temples 3 rotate, respectively, with the two pivoting elements 13 as pivots. The front end surfaces 32 of the two temples 3 rotate and push against the resisting ends 21 of the two elastic members 2, so that the resisting ends 21 are in an elastic compressed state. After the inner side surfaces 33 of the temples 3 rotate and abut against the resisting ends 21 of the elastic members 2, respectively, the resisting ends 21 of the elastic members 2 elastically return and resist the inner side surfaces 33 of the temples 3, and the temples 3 are positioned in a folded state. The temples 3 are capable of firmly positioning themselves in the folded state by the resistance of the elastic members 2, and the two temples 3 will not expand outward at will, so that the temples 3 have a clamping function that can be firmly clamped on the collar or pocket of clothing, thereby the spectacle are clamped on clothing and will not fall off. When the spectacle need to be used again, only a force needs to be applied to the two temples 3 to pull them outward, so that the two temples 3 can be opened outward for the user to wear (as shown in FIG. 4), which is extremely convenient in use and folding, and through setting the elastic members 2, the pivot connection between the frame 1 and the temples 3 is more stable and not easy to loosen.

In summary, the present invention has achieved the expected objects and effects, and is more ideal and practical than prior art. However, the above-mentioned embodiments are only for specifically describing the preferred embodiments of the present invention, and the embodiments are not intended to limit the scope of the present application. Also, other equivalent changes and modifications made without departing from the technical means disclosed in the present invention are intended to be included in the patent scope of the present invention.

What is claimed is:

1. A spectacle structure, comprising a frame, two elastic members, and two temples respectively arranged thereon, wherein the frame has a pivoting part each provided at two ends thereof, a slot provided in the pivoting part, a through hole provided on the pivoting part and penetrates the slot, a pivoting element provided in the through hole, a receiving groove provided in the slot, and an engaging groove each corresponding to the upper and lower sides of one side of the receiving groove, wherein the two elastic members are respectively assembled in the receiving grooves of the two pivoting parts of the frame, wherein the elastic member has a positioning end provided at one end thereof and a resisting end provided at the other end thereof, wherein the positioning end is snapped in the engaging groove of the frame, wherein the two temples are respectively assembled on the two pivoting parts of the frame, wherein the temple has a pivoting lug provided at a front end thereof and arranged in the slots of the frame, a passing hole provided on the pivoting lug, and a front end surface of the pivoting lug of the temple resisted by the resisting end of the elastic member.

2. The spectacle structure, as recited in claim 1, wherein the pivoting element includes a fixed sleeve and a screw arranged thereon, wherein the fixed sleeve is inserted into the through hole of the pivoting part of the frame and the passing hole of the temple, wherein the screw is screw-locked in the fixed sleeve.
